(19) United States
(12) Patent Application Publication
(10) Pub. No.: US 2009/0087309 A1
(43) Pub. Date: Apr. 2, 2009

(54) Protective ring for the fan casing of a gas-turbine engine

(76) Inventor: Karl Schreiber, Am Mellensee (DE)

Correspondence Address: Timothy J. Klima;Harbin King & Klima, 500 Ninth Street SE, Washington, DC, 20003, US

(21) Appl. No.: 11/979,547

(22) Filed: Nov. 5, 2007

(30) Foreign Application Priority Data
Nov. 6, 2006 (DE) 10 2006 052 498.5

(51) Int. Cl. F01D 21/00; F01D 25/24; F02C 7/00

(52) U.S. Cl. 415/200; 415/9; 60/39.091

(57) ABSTRACT

A protective ring (7) for a fan casing (2) of a gas-turbine engine equipped with a fan having especially metallic fan blades (3) includes a one-piece fiber-composite ring (8) with a ceramic cover (9) arranged on the ring inner surface facing the fan blades, and preferably formed by individual panels embedded in a ductile material, this cover (9)—upon the impingement of broken-off blade fragments—forms a crack network corresponding to an arrangement of the sintered starting ceramic particles and subsequently disintegrates into small particles, thereby absorbing a great part of the kinetic energy caused by the impinging blade fragment. Consequential damage to the protective ring is thereby minimized.

This application claims priority to German Patent Application DE 10 2006 052 498.5 filed Nov. 6, 2006, the entirety of which is incorporated by reference herein.

This invention relates to a protective ring for the fan casing of a gas-turbine engine, the protective ring being made of a fiber-composite material.

The fan or the fan blades of a gas-turbine engine can be damaged or even destroyed by ingested foreign objects, for example large birds. Fragments of failed blades may damage the engine or even the aircraft if they break through the engine casing. In order to avoid consequential damage due to blade failure, the fan, as is generally known, is enclosed by a protective casing to preclude the blade fragments from breaking through the engine and prevent the engine from being damaged. Such fan protective casings are made in various forms, for example in metal, fiber-composite materials or a combination of metals and fiber composites.

Specification EP 1 674 671 describes a fan protective casing which is disposed on the inner circumference of the metallic engine casing and consists of a plurality of circumferentially orientated, woven fiber layers and synthetic resin layers provided between the fiber layers and which, besides its protective effect, is characterized by relatively low weight owing to the absence of metallic components.

However, the protective function of a fan protective casing made of fiber-composite materials, which is characterized by high stiffness and structural strength as well as low manufacturing costs, is inadequate for metallic fan blades since the surface on the inside of the fiber-composite protective ring lacks sufficient hardness and strength. In the event of a blade failure, the broken-off fragments of metallic fan blades, due to high kinetic energy and load concentration, may therefore cause local damage to the surface of the fiber-composite material which, in the windmilling case, is aggravated by the imbalance of the fan and the vibration of the engine casing resulting therefrom and may lead to complete destruction of the fiber-composite protective casing. Moreover, separated fragments of a damaged fan blade can get stuck in the composite material and damage the following fan blades.

A broad aspect of the present invention is to provide a fiber-composite protective ring for the fan casing of a gas-turbine engine equipped with a fan comprising metallic or fiber-composite blades such that the fiber structure of the protective ring is not destroyed and serious consequential damage to the fan casing, the fan blades or the engine is avoided in the event of a blade failure.

The present invention is based on a protective ring for the fan casing which is at least partly made of fiber-composite material (hybrid). A cover made of ceramic material is provided on the fiber-composite material to minimize consequential damage due to the separation of blade fragments caused, for example, by foreign objects or fatigue, in particular also if metallic fan blades are used. Thus, an impinging blade portion will not exert a concentrated load on the fiber-composite material, but an areal load which distributes the forces. The ceramic cover is capable of absorbing a considerable part of the kinetic energy of the impinging blade portion since a crack network initially forms in the cover and the ceramic material subsequently disintegrates into small particles or even the starting particles sintered during manufacture. The destroyed ceramic material in the form of small, disintegrated particles is discharged downstream without causing further damage. Accordingly, consequential damage is essentially avoided which is expected to occur on a protective ring made fully or partly of fiber-composite material which is used with a fan, in particular a fan with metallic blades, upon damage to the latter.

In accordance with a further feature of the present invention, the cover includes individual ceramic panels, preferably in a shape in which the panel edges abut each other at an obtuse angle. The ceramic panels are preferably hexagonal.

The ceramic panels are bonded to the fiber-composite ring via a ductile adhesive and the joints filled with a ductile adhesive. The joints are preferably orientated such that they do not extend in a running direction of the fan blades. In a development of the present invention, the ceramic panels may also be embedded in rubber. Ductile embedment of the ceramic panels is intended to de-couple the shock waves occurring during impact. The overall design in fiber-composite material and ceramic panels embedded in ductile material is characterized by excellent damping characteristics. This is also helped by reinforcing ribs optionally formed onto the protective ring made of fiber-composite material.

In accordance with a particularly preferable embodiment of the present invention, the ceramic panels are provided with a crowned surface so that detached blade fragments will centrally strike the ceramic panels rather than impinge on their edges.

As ceramic material, silicon carbide or aluminum oxide or boron carbide are preferably used.

In a further development of the present invention, the fiber-composite ring covered with ceramic material preferably includes wound, polymer-matrix embedded carbon or glass fibers, with alternately arranged glass-fiber and carbon-fiber strands forming a one-piece wound netting of crossing and overlapping winding layers. For manufacture, other known methods, for example prepreg mats, resin infiltration and the like may, however, also be used. Likewise, other known fibers and fiber combinations may be employed.

The present invention is more fully described in the light of the accompanying drawings showing a preferred embodiment. In the drawings,

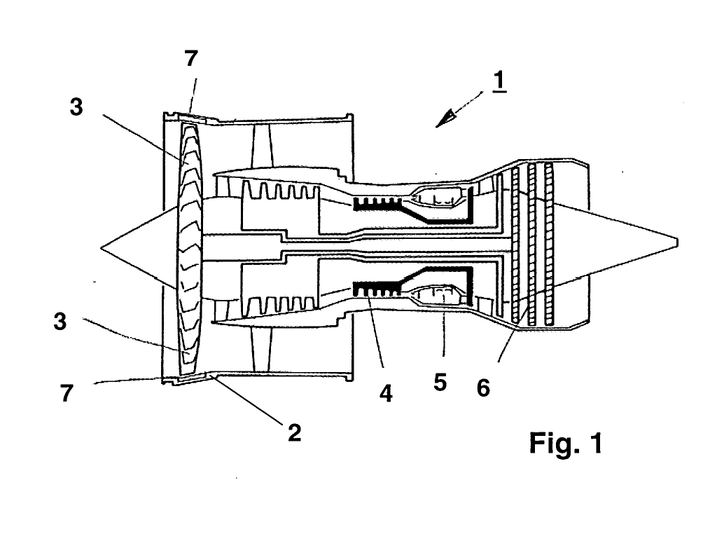

FIG. 1 is a schematic representation of a fan gas-turbine engine with a protective ring integrated in the fan casing,

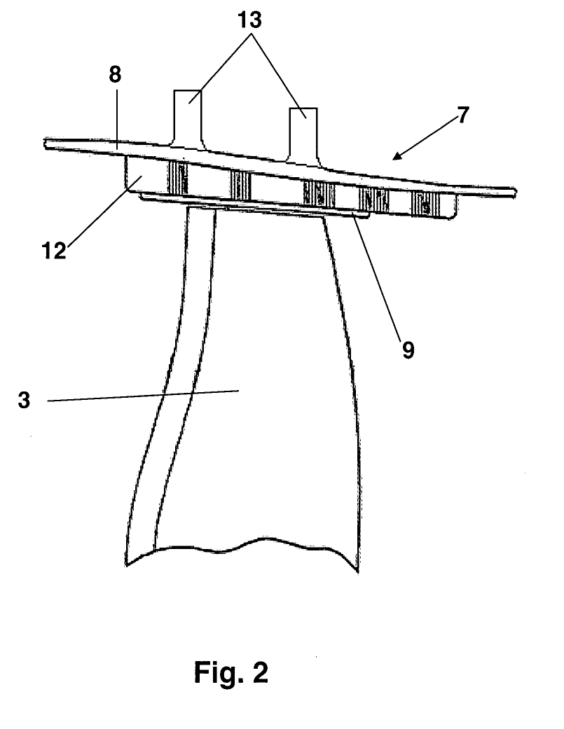

FIG. 2 is a sectional view of a protective ring made of fiber-composite material with a ceramic cover provided on the inner surface facing the fan blades,

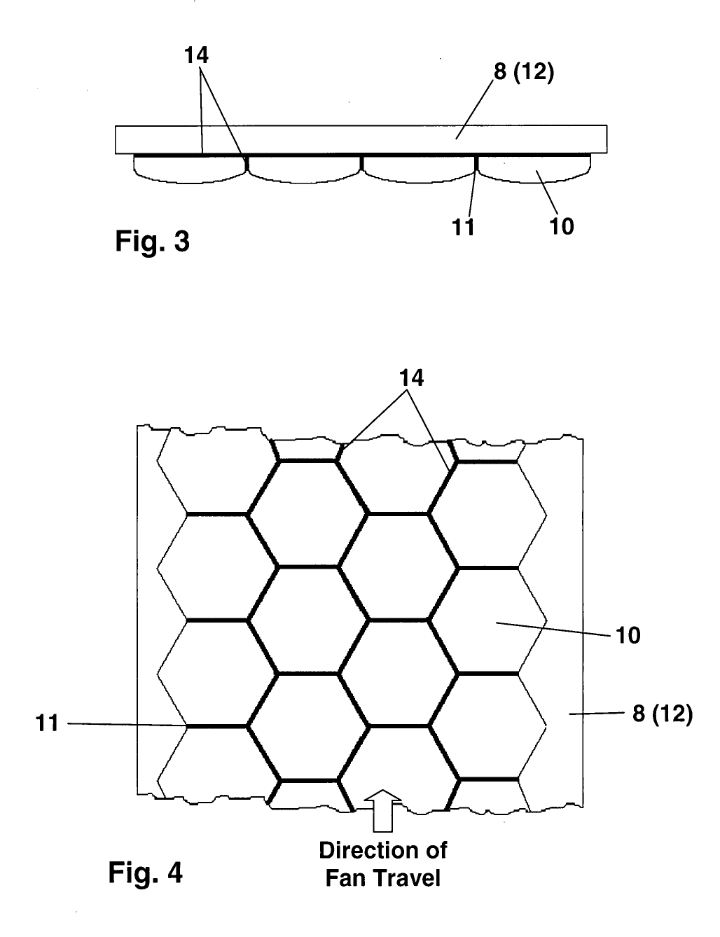

FIG. 3 is an enlarged sectional view of the protective ring, and

FIG. 4 is a top view of part of the protective ring inner surface.

The fan gas-turbine engine 1 shown in FIG. 1 essentially comprises the fan with titanium fan blades 3 enclosed by the fan casing 2, a compressor 4, a combustion chamber 5 and a turbine 6. A protective ring 7, which is shown in an enlarged partial sectional view in FIG. 2, is provided on the inner circumference of the fan casing 2 to protect the latter. Fragments detached from the fan blades 3 by impinging foreign objects or in another way are kept away from the engine casing and can be axially discharged.

The protective ring 7 shown in enlarged view in FIG. 2 includes a fiber-composite ring 8 with a honeycomb structure 12 provided on the inner surface of the fiber-composite ring 8 and a ceramic cover 9 attached thereto.

In accordance with the present embodiment, the fiber-composite ring 8 includes a one-piece wound netting of crossing and overlapping winding layers. A resin is infiltrated into the netting and applied to its surface. The preferably pre-impregnated winding layers of the netting include parallel, adjacent glass fiber and carbon fiber strands in alternating arrangement. On the outer circumferential surface of the fiber-composite ring 8, reinforcing ribs 13 integrally wound with the fiber-composite ring 8 are provided to avoid reverberation in the event of an impact onto the fiber-composite ring 8 or the protective ring 7, respectively.

The ceramic cover 9 preferably includes adjacent ceramic panels 10 made of silicon carbide. The ceramic panels 10 are preferably hexagonal and oriented such that the joints 11 between adjacent ceramic panels 10 do not extend in the running direction of the fan blades 3. The ceramic panels 10 are preferably attached with a ductile adhesive 14 (and/or rubber or other ductile material mat 14), with the joints 11 existing between the ceramic panels 10 being filled with the ductile adhesive 14 (and/or rubber or other ductile material) to improve the damping behavior. The ceramic panels 10 are preferably crowned on the outer side facing the fan blades 3.

The fiber-composite ring 8 is characterized by high stiffness and damping efficiency, high structural strength and low manufacturing cost, with crack propagation upon damage being relatively low on account of the fiber structure described in the above. Owing to the ceramic cover 9, 10 a detached blade fragment impinging on the protective ring 7 with high kinetic energy will not exert a concentrated load, but an areal load distributed over the fiber structure, onto the fiber-composite material, as a result of which penetration resistance (bulletproof) of the protective ring 7 is considerably enhanced.

Upon impingement of a detached metallic blade fragment, a crack network corresponding to the starting powder sintered during manufacture is initially formed in the ceramic cover. This allows the cover to disintegrate into small particles. While the ceramic cover is thus capable of absorbing a great part of the impact energy, the small ceramic particles are discharged from the engine without causing damage. Since the ceramic cover 9 is made of individual ceramic panels 10, only a limited portion of the cover will be destroyed by an impact, while the other, unaffected ceramic panels 10 remain intact. With the ceramic panels 10 being hexagonal, the joints 11 are not continuous so that the area of action of the fan blade fragments striking the ceramic panels 10 at a shallow, tangential angle is small at the edges of the ceramic panels 10.

As shown in FIG. 3, the ceramic panels 10 are also crowned on the inner side facing the fan blades 3 so that fan blade fragments will centrally strike the ceramic panels 10 rather than impinge on the edges of the ceramic panels 10 or the joints 11, thereby obtaining optimum force introduction into the ceramic material. Embedment of the ceramic panels 10 in a ductile material (adhesive, rubber or similar) considerably contributes to damping upon impact.

The present invention is not limited to the above embodiment. For example, another polygonal or curved shape of the ceramic panels or the use of another ceramic material, such as aluminum oxide or boron carbide, is possible. The above-described protective ring is, in particular, used on gas turbine engines whose fan is equipped with blades consisting of metal.

With a fiber-composite protective ring for the fan casing, damage to the fiber-composite material caused by a metallic blade fragment is significantly reduced and consequential damage in the form of crack propagation or due to blade fragments getting stuck in the fiber-composite material during windmilling avoided.

### LIST OF REFERENCE NUMERALS

1 Fan gas-turbine engine
2 Fan casing
3 Fan blades
4 Compressor
5 Combustion chamber
6 Turbine
7 Protective ring
8 Fiber-composite ring
9 Ceramic cover
10 Ceramic panels
11 Joints
12 Honeycomb structure
13 Reinforcing ribs
14 Ductile adhesive, rubber, ductile material

What is claimed is:

1. A fiber-composite protective ring for a fan casing of a gas-turbine engine having a fan with metallic fan blades, comprising:
a fiber-composite ring having an inner surface facing the fan blades;
a ceramic cover covering the inner surface of the fiber-composite ring.

2. The protective ring in accordance with claim 1, wherein the ceramic cover is constructed of at least one of sintered silicon carbide powder, aluminum oxide powder and boron carbide powder.

3. The protective ring in accordance with claim 2, wherein the cover includes individual ceramic panels, with joints being provided between adjacent panels.

4. The protective ring in accordance with claim 3, wherein the ceramic panels have a shape in which edges of the panels abut each other at obtuse angles.

5. The protective ring in accordance with claim 3, wherein the ceramic panels are hexagonal.

6. The protective ring in accordance with claim 4, wherein the ceramic panels include crowned surfaces, which face the fan blades.

7. The protective ring in accordance with claim 3, and further comprising a ductile adhesive for bonding the ceramic panels to the inner surface of the protective ring and filling the joints.

8. The protective ring in accordance with claim 3, and further comprising a rubber mat in which the ceramic panels are embedded such that the joints are filled with rubber.

9. The protective ring in accordance with claim 3, wherein the joints extend at least one of diagonally or obliquely to a running direction of the fan blades.

10. The protective ring in accordance with claim 1, wherein the fiber-composite ring includes at least one of carbon, glass, polyethylene, aramide fibers and various combinations thereof, and is constructed by at least one of winding, weaving, knitting and infiltration of synthetic resin, or of prepreg mats.

11. The protective ring in accordance with claim 10, wherein the fiber-composite ring includes reinforcing ribs constructed of fiber-composite material and integrally formed on an outer circumference of the fiber-composite ring.

12. The protective ring in accordance with claim 10, wherein the fiber-composite ring is constructed of wound carbon fibers and glass fibers embedded in a polymer matrix.

13. The protective ring in accordance with claim 12, wherein the carbon and glass fibers are formed as a one-piece wound netting of crossing and overlapping winding layers, which include alternately and parallelly arranged adjacent glass fiber and carbon fiber strands of similar thickness.

14. The protective ring in accordance with claim 1, wherein the cover includes individual ceramic panels, with joints being provided between adjacent panels.

15. The protective ring in accordance with claim 14, wherein the ceramic panels have a shape in which edges of the panels abut each other at obtuse angles.

16. The protective ring in accordance with claim 14, wherein the ceramic panels are hexagonal.

17. The protective ring in accordance with claim 14, wherein the ceramic panels include crowned surfaces, which face the fan blades.

18. The protective ring in accordance with claim 14, and further comprising a ductile adhesive for bonding the ceramic panels to the inner surface of the protective ring and filling the joints.

19. The protective ring in accordance with claim 14, and further comprising a rubber mat in which the ceramic panels are embedded such that the joints (11) are filled with rubber.

20. The protective ring in accordance with claim 14, wherein the joints extend at least one of diagonally or obliquely to a running direction of the fan blades.
